(19) United States
(12) Patent Application Publication
(10) Pub. No.: US 2014/0351088 A1
(43) Pub. Date: Nov. 27, 2014

(54) COMPUTER-IMPLEMENTED REAL ESTATE INFORMATION DELIVERY SYSTEM AND METHOD

(71) Applicant: Ashish Saxena, Mississauga (CA)

(72) Inventor: Ashish Saxena, Mississauga (CA)

(21) Appl. No.: 13/899,954

(22) Filed: May 22, 2013

(51) Int. Cl. G06Q 30/06; G06Q 50/16

(52) U.S. Cl. CPC G06Q 30/0621; G06Q 50/16; G06Q 30/0613
USPC 705/26.41; 705/26.5

(57) ABSTRACT

Disclosed is a real estate information delivery system for assisting a user in choosing a neighborhood so as to purchase, rent, or lease a real estate property therewithin. The system comprises a database comprising a plurality of neighborhood entries representing neighborhoods. Each neighborhood entry is associated with a plurality of neighborhood factor scores wherein, a factor score represents a score of a predetermined neighborhood factor that potentially influences the decision pertaining to the purchasing, renting, or leasing of a real estate property within the neighborhood. The system is configured to enable a user, via a user interface, to choose a plurality of predetermined factors that form the criteria of the user in selecting a neighborhood. Each chosen factor is assigned a percentage weightage value. A calculation module calculates, for each neighborhood, the weighted average of the factor scores pertaining to the user-chosen factors.

### BACKGROUND

The present invention relates to various computer-implemented systems and methods that deliver information to a user in response to a search performed thereon. More particularly, the present information relates to such systems and methods that serve up information specifically related to real estate.

For people interested in purchasing or renting real estate property, be it for home or commercial purposes, a great deal of importance is attached to the neighborhood or locality wherein the real estate property is located. Various attributes of the neighborhood are factored into the decision making process pertaining to the purchasing or renting of the real estate property. The attributes could be proximity factors such as, the distance between the real estate property and a public transportation terminal, or a school, or any other specific location such as, the location of family, work place, etc. The attributes may also be demographic in nature such as, the general ethnicity of people in the neighborhood, the average household income of the residents, or the education levels of the neighborhood, etc.

Generally, for such information, a prospective customer has no choice but to rely on real estate broker, who in turn may skew the information to his/her advantage. Another source of such information could be the Internet, but the information provided there is distributed across various websites and is therefore, unstructured. In other words, there is no one such place on the Internet where a prospective customer could find the type of neighborhood information that one desires to have. Better yet would be such a virtual system, where the prospective customer could not only search for real estate property online, but also search properties based on attributes related to proximity and demographic factors. They can also obtain information on the neighborhoods within which the interested real estate properties are located. Still better yet would be such a virtual system that not only enables the prospective customer to look for real estate properties and find neighborhood information, but also obtain information on various brokers that deal with real estate properties within the interested neighborhood(s).

### SUMMARY

The present invention comprises a computer-implemented real estate information delivery system comprising a database comprising a plurality of categorized neighborhood entries wherein, each neighborhood entry represents a neighborhood. Each neighborhood entry is associated with a plurality of factor scores wherein, a factor represents the score of a predetermined neighborhood factor that has influence on the renting or purchasing a real estate property with the neighborhood. A user, in order to obtain information on neighborhoods in order to buy or rent real estate property therewithin, is allowed to choose a plurality of predetermined factors and assign a percentage weightage value to each of the chosen factors. Once there, a calculation module calculates weighted averages of each applicable neighborhood. These weighted averages are displayed in an orderly manner so as to assist the user in choosing a neighborhood.

Other objects and advantages of the embodiments herein will become readily apparent from the following detailed description taken in conjunction with the accompanying drawings.

### BRIEF DESCRIPTION OF THE DRAWINGS

FIG. 1 is a block diagram of the computer-implemented real estate information delivery system according to an embodiment of the present invention.

FIG. 2 is database matrix associating neighborhood entries with real estate property types and neighborhood factor scores according to an embodiment of the present invention.

FIG. 3 is a database matrix associating neighborhood entries with a plurality of neighborhood scores pertaining to predetermined neighborhood factors that are dependent according to an embodiment of the present invention.

FIG. 4 is an exemplary screenshot of the user interface that enables the user to input his/her choice of predetermined factors along with their weightage values according to an embodiment of the present invention.

FIG. 5 is an exemplary screenshot depicting, among other listings, the weighted averages of the neighborhoods according to an embodiment of the present invention.

FIG. 6 is an exemplary screenshot of a graphical representation of the breakup of the age of residents of neighborhood JKL.

FIG. 7 is an exemplary screenshot of a pictorial representation of the breakup of the ethnicity of residents of neighborhood JKL.

FIG. 8 is an exemplary screenshot of a graphical representation of the 5-year growth of neighborhood JKL vis-à-vis the city/town thereof.

FIG. 9 is a flowchart mapping the computer-implement real estate information delivery method according to an embodiment of the present invention.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

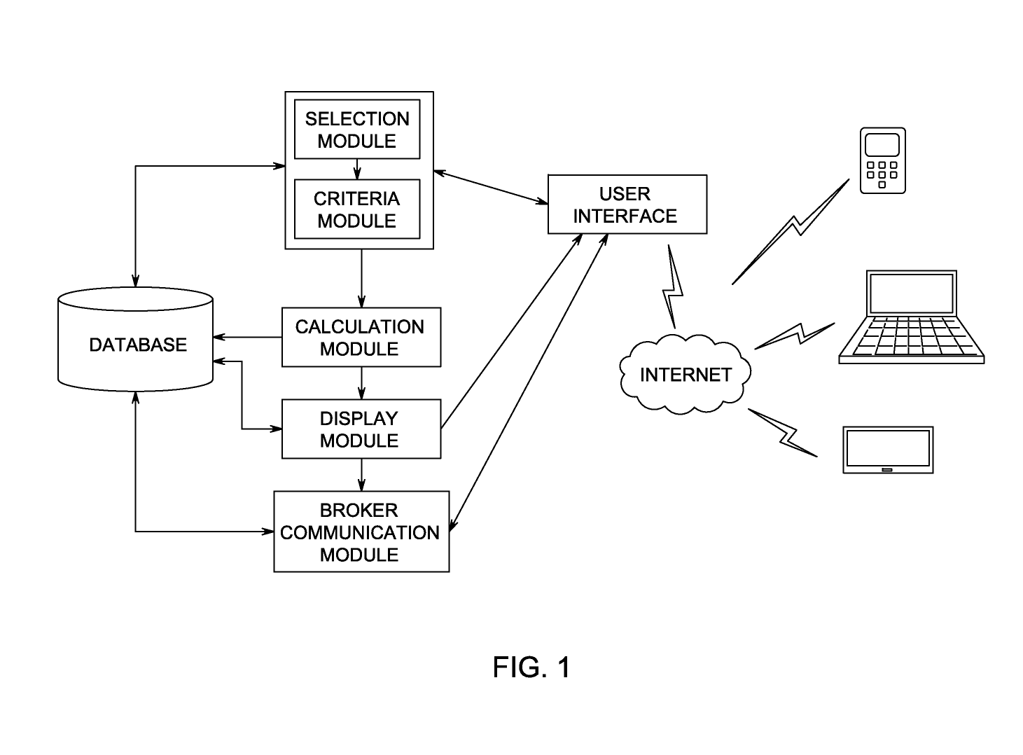

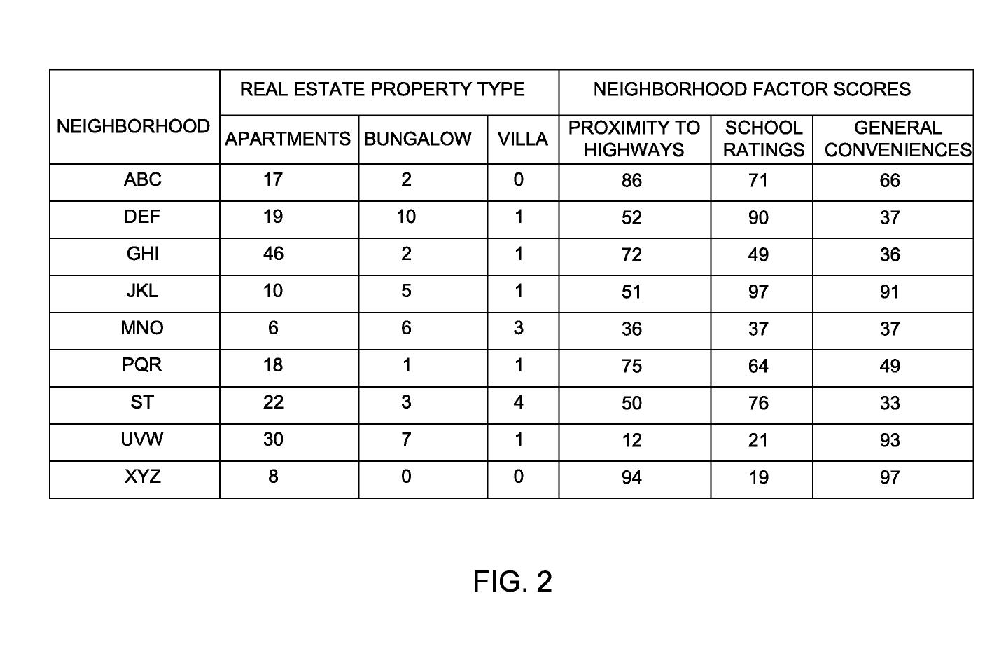

Referring to FIG. 1, the present invention comprises a computer-implemented real estate information delivery system comprising a database accessible through a user interface via a communications device such as a laptop, mobile phone, etc, as enabled by a communications network such as the Internet. The database comprises a plurality of categorized neighborhood entries wherein, each neighborhood entry represents a neighborhood within a human settlement—a village, town or a city. In one embodiment, the neighborhood entries that are within a human settlement are further categorized by directional orientations such as, north, south, east, west and central. Each neighborhood entry is associated with a plurality of property type numbers, each of which, represents the number of real estate properties pertaining to a real estate property type that are located within the neighborhood. For example, a real estate property type could be an apartment, a bungalow, a villa, etc. For example, from FIG. 2, it can be inferred that the neighborhood represented by the neighborhood entry ABC tabulated in the database has 17 apartments, 2 bungalows, and 0 villas available for rent or purchase.

Each neighborhood entry is further associated with a plurality of neighborhood factor scores wherein, each factor score, which is preferably between zero and one hundred, represents the score of a predetermined neighborhood factor that influences the decision pertaining to the purchasing or renting of a real estate property within the corresponding neighborhood. The predetermined factors could be proximity to highways, work place, family, public transportation hub, school ratings (or quality of schools within the neighborhood), ethnicity, age, education, average income of the residents, etc. For example, referring to FIG. 2, for the neighborhood entry PQR in the database, the predetermined factor “proximity to highways” has a good score of 75 (out of 100), while the predetermined factor “school ratings” has a moderate score of 64 (out of 100). As the higher the factor score, the better the neighborhood in terms of the corresponding predetermined factor, the neighborhood represented by the neighborhood entry PQR has a satisfactory proximity to highways while, in terms of the schools it has, the neighborhood, as stated earlier, is moderate.

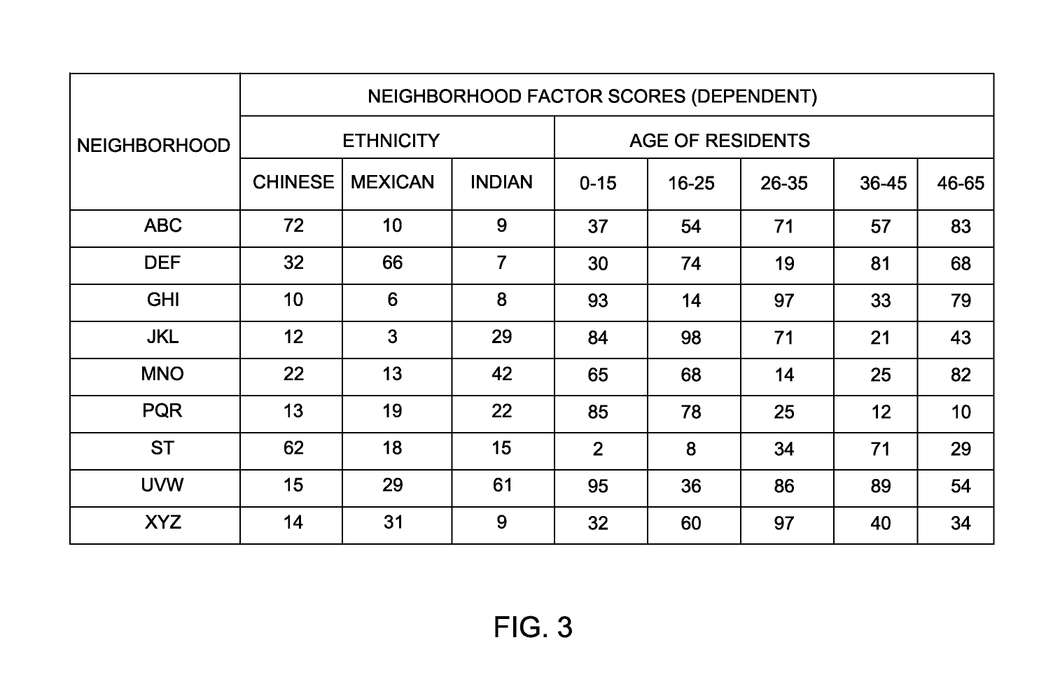

While some of the predetermined factors are independent (ex: proximity to highways, public transportation hub, school ratings), the others (ex: age, average income, ethnicity of residents, proximity to a particular) are dependent on sub-factors such as, values, ranges, etc. Just the way every independent predetermined factor is scored, every sub-factor is scored similarly. For instance, in FIG. 3, the neighborhood represented by the neighborhood entry GHI has a population predominantly composed of an age group ranging between 0 to 15 years and 26 to 35 years as the factor score assigned to the “0 to 15” and “26 to 35 year age group” sub-factors are higher than the rest of the age group sub-factors. In another instance, still referring to FIG. 3, it can be inferred that the neighborhood represented by the neighborhood entry ABC is predominantly a Chinese neighborhood as the sub-factor “Chinese” scores more than any other sub-factor listed under the predetermined factor “Ethnicity.” The score of every predetermined factor and sub-factor is calculated from authentic data sourced from population census, or other public records. In one embodiment, a ranking system is incorporated wherein, each neighborhood is assigned a rank based on its factor and sub-factor scores; the higher the factor score, the better the rank.

Each neighborhood entry is further associated with at least one broker entry wherein, a broker entry represents a real estate broker, who specializes in real estate deals within the corresponding neighborhood. Each broker entry is further associated with details pertaining to the corresponding real estate broker such as, the experience of the broker, number of deals closed, age, contact details, etc.

Referring back to FIG. 1, the system further comprises a selection module for enabling a user, via the user interface, to select at least one geographical area of interest wherein, a geographical area may span more than one human settlement, or a part(s) of a human settlement, which may or may not be contiguous. For instance, a user may be interested in either Toronto or Ottawa in Canada. In another instance, a user might be looking for real estate property located just in northern part of Toronto. In yet another instance, the user can even more specifically choose a plurality of neighborhoods within the northern side of Toronto. In one embodiment, the system may be configured such that, a map is shown along with the geographical area(s) selected by the user being color-coded. The selection module further enables the user to limit his/her real estate property type. For instance, the user may be interested in renting or purchasing apartments alone. The selection module thus enables a user, via the user interface, to select his geographical areas and real estate property types of interest by selecting (or deselecting) various menu options.

Still referring to FIG. 1, the system further comprises a factor module for enabling a user to select, via the user interface, a plurality of predetermined factor that he/she deems crucial for selection of a neighborhood. For example, a user may be looking for a neighborhood that may be closer to his/her work place, has good quality schools in the neighborhood, or has good variety of general conveniences. In another example, a user may be interested in neighborhoods that have a predominant Chinese ethnicity. In yet another example, the user may be keen on neighborhoods that have a population, which is predominantly composed of an age group ranging between 26 to 35 years. In one embodiment, the plurality of predetermined factors may comprise a predetermined number of predetermined factors. Alternatively, the user himself/herself may be allowed to decide how many predetermined factors he/she want to be factored in.

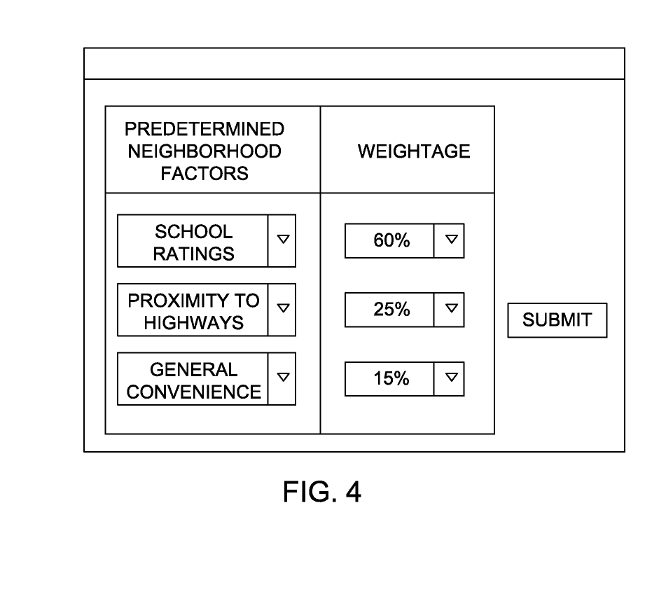

Once the predetermined factors (and sub-factors) are chosen by the user, the user is prompted to further input or assign a percentage weighting or weightage value (between zero and one hundred) to each of the chosen factors (and sub-factors) such that, the sum of all the individual percentage weightage values equal one hundred. An exemplary screenshot of the user interface shown in FIG. 4 shows a weightage value of 60% assigned (from a drop-down menu) to the predetermined factor “School Ratings”, 25% to “Proximity to Highways,” and 15% to “General Convenience.” From this example, it can be inferred that the user attached a great deal of importance to school ratings compared to the other two predetermined factors.

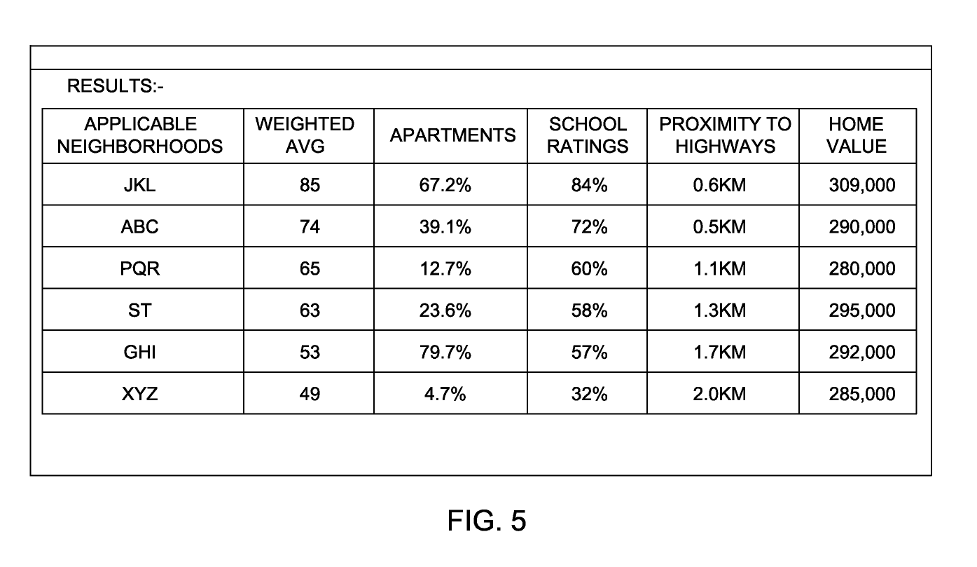

Referring to FIG. 1, the system further comprises a calculation module for calculating, for each applicable neighborhood (i.e., the neighborhood that is within the geographical area(s) earlier selected by the user as enabled by the selection module), the weighted average of factor scores pertaining to the chosen predetermined factors (and sub-factors). Once there, a display module retrieves the weighted average values of all the applicable neighborhoods and displays them in an orderly fashion, preferably from most to least favorable; the most favorable neighborhood being the one which has highest weighted average. Also apart from weightage values, the values or scores of the predetermined factors are also displayed along. Referring to FIG. 5, which is the screenshot depicting the result of earlier example, each applicable neighborhood is listed with number of real estate property types specified by the user available in the neighborhood, the percentage value of school ratings, distance from the center of the neighborhood to the nearest highway, and the list of general conveniences available in the neighborhood. In one embodiment, additional information (for example, average real estate property value pertaining to the real estate property type specified by the user) may be displayed along with what is “asked for” by the user.

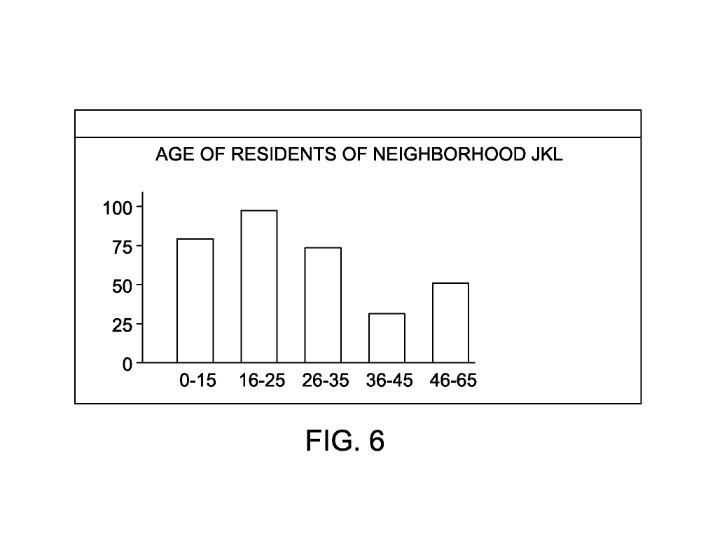

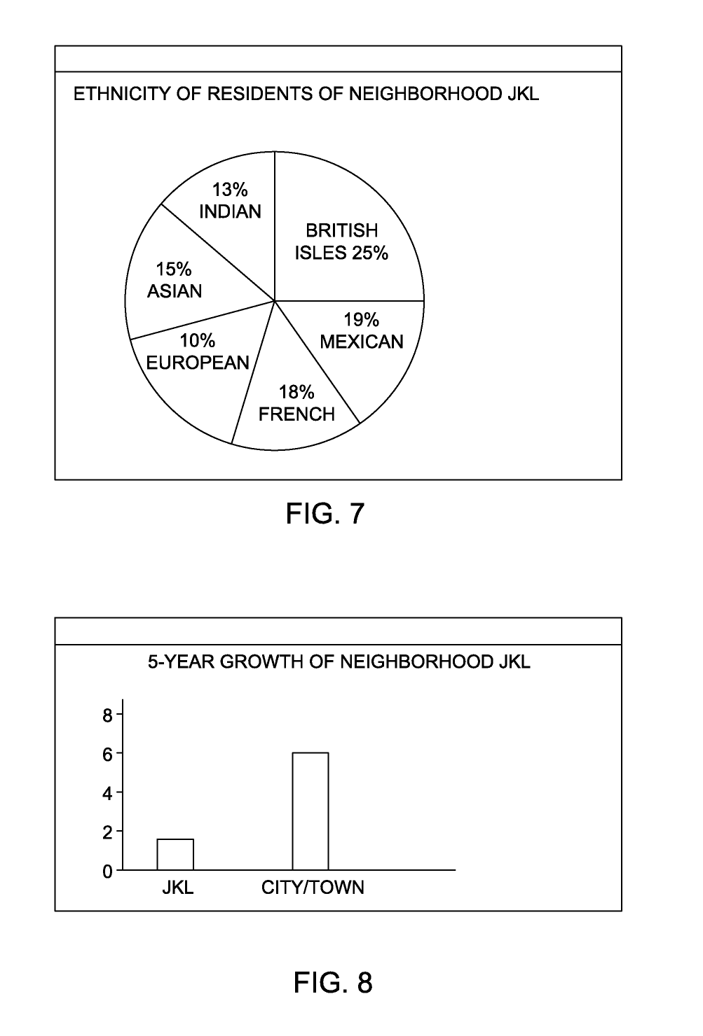

In one embodiment, the system is configured such that, if one of the displayed neighborhoods is selected by the user to have a “look” at it, all the data pertaining to the neighborhood (including the predetermined factors not chosen by the user) is presented to the user. For example, an exemplary screenshot depicting age and nationality of residents of the neighborhood JKL is presented to the user graphically or pictorially as can be seen in FIGS. 6 and 7. In another example 5-year growth of the neighborhood JYK vis-à-vis the human settlement thereof is graphically depicted FIG. 8.

Referring to FIG. 1, the system further comprises a broker communication module for enabling the user to access the details of real estate broker(s) that specialize in the selected neighborhood. The user is allowed to access the details of the real estate broker(s), which as mentioned earlier, include the experience of the broker(s), the age, the contact details, the number of deals closed, etc. In one embodiment, the system is configured such that, no contact information or identity of a broker is disclosed unless a predetermined fee is paid by the user.

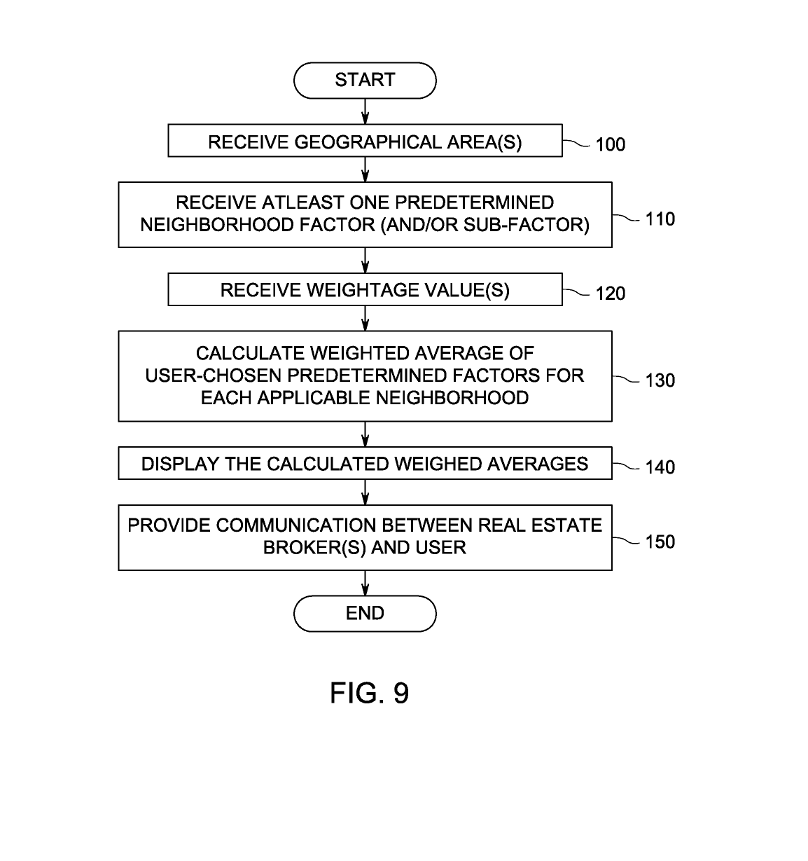

Referring to FIG. 9, the computer-implemented real estate information delivery method of the present invention initiates at step 100 with receiving, from a user, via a user interface of a computer-implemented system, information of a specific geographical area(s) within which the user is interested in purchasing, renting, or leasing real estate property. A geographical area could be a plurality of neighborhoods that may span at least one human settlement—a village, town or a city, or a plurality of neighborhoods within a human settlement. The neighborhood may or may not be contiguous. Once the information on geographical area(s) is received, at step 110, the user's criteria for the selection of a neighborhood are received, via the user interface, in the form of a plurality of predetermined neighborhood factors. The predetermined factors include proximity to highways, work place, family, public transportation hub, school ratings (or quality of schools within the neighborhood), ethnicity, age, education, average income of the residents, etc. Each of the predetermined factors pertaining to a neighborhood is assigned a neighborhood factor score calculated from authentic data sourced from population census, or other public records. The neighborhoods (as neighborhood entries) along with the corresponding factor scores (pertaining to the predetermined factors) are listed within a database which is configured to be in communication with the user interface.

Still referring to FIG. 9, at step 120, each of the chosen predetermined factors is assigned a percentage weightage value such that, the sum of all the individual percentage weightage values equals one hundred. The higher the percentage value, the greater importance is attached to the predetermined factor. At step 130, for each neighborhood within the geographical area specified by the user, a weighted average of the factor scores pertaining to the user-chosen predetermined factors is calculated. At step 140, the calculated values are displayed in an orderly fashion, preferably in a descending order; the neighborhood with the highest weighted average being most favorable. Each neighborhood entry is further associated with at least one broker entry wherein, a broker entry represents a real estate broker, who specializes in real estate deals within the corresponding neighborhood. Each broker entry is further associated with details pertaining to the corresponding real estate broker such as, the experience of the broker, number of deals closed, age, contact details, etc. At step 150, a communication, upon the consent of the user, is established between the user and the real estate broker(s) pertaining to a neighborhood selected from the displayed list of neighborhoods.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

What is claimed is:

1. A computer-implemented real estate system for assisting a user in choosing a neighborhood from a plurality of neighborhoods so as to purchase, rent, or lease a real estate property therewithin, the computer-implemented system comprising:
(a) a database comprising a plurality of categorized neighborhood entries, each neighborhood entry representing a neighborhood, each neighborhood entry associated with a plurality of neighborhood factor scores wherein, each factor score represents a score of a predetermined neighborhood factor that potentially influences the decision pertaining to the purchasing, renting, or leasing of a real estate property within the neighborhood, the higher the factor score, the better the neighborhood in terms of the factor;
(b) a user interface;
(c) a criteria module for enabling a user, via the user interface, to choose a plurality of predetermined factors that form the criteria of the user in selecting a neighborhood so as to purchase, rent, or lease a real estate property therewithin, each chosen factor being weighted;
(d) a calculation module for calculating, for each neighborhood, the weighted average score of the factor scores pertaining to the user-chosen factors; and
(e) a result module for displaying the neighborhoods along with the weighted average scores thereof in an order.

2. The computer-implemented system of claim 1 wherein, the chosen predetermined factors are weighted by the user.

3. The computer-implemented system of claim 1 further comprising a selection module for enabling the user, via the user interface, to limit the neighborhoods.

4. The computer-implemented system of claim 1 wherein, a predetermined factor is dependent on at least one sub-factor.

5. The computer-implemented system of claim 1 wherein, the plurality of predetermined factors comprise proximity factors such as, distance between a neighborhood and a particular geographical location, distance between a neighborhood and a nearest freeway, and distance between a neighborhood and a public transportation hub.

6. The computer-implemented system of claim 1 wherein, the plurality of predetermined factors comprise demographic factors such as, age, education, ethnicity, and income of residents.

7. The computer-implemented system of claim 1 wherein, each neighborhood entry is associated with at least one broker entry wherein, a broker entry represents a real estate broker.

8. The computer-implemented system of claim 7 further comprising a broker communication module for enabling the user and a broker to communicate with one another.

9. A computer-implemented real estate method for assisting a user in choosing a neighborhood from a plurality of neighborhoods so as to purchase, rent, or lease a real estate property therewithin, the computer-implemented method comprising:
(a) listing a plurality of categorized neighborhood entries within a database, each neighborhood entry representing a neighborhood, each neighborhood entry associated with a plurality of neighborhood factor scores wherein, each factor score represents a score of a predetermined neighborhood factor that potentially influences the decision pertaining to the purchasing, renting, or leasing of a real estate property within the neighborhood, the higher the factor score, the better the neighborhood in terms of the factor;
(b) enabling a user, via a user interface, to choose a plurality of predetermined factors that form the criteria of the user in selecting a neighborhood so as to purchase, rent, or lease a real estate property therewithin, each chosen factor being weighted;
(c) calculating, for each neighborhood, the weighted average score of the factor scores pertaining to the user-chosen factors; and
(d) displaying, on the user interface, the neighborhoods along with the weighted average scores thereof in an order.

10. The computer-implemented method of claim 9 wherein, the chosen factors being weighted by the user.

11. The computer-implemented method of claim 9 further comprising a selection module for limiting the number of neighborhoods.

12. The computer-implemented method of claim 9 wherein, a factor is dependent on at least one sub-factor.

13. The computer-implemented method of claim 9 wherein, the plurality of predetermined factors comprise proximity factors such as, distance between a neighborhood and a particular geographical location, distance between a neighborhood and a nearest freeway, and distance between a neighborhood and a public transportation hub.

14. The computer-implemented method of claim 9 wherein, the plurality of predetermined factors comprise demographic factors such as, age, education, ethnicity, and income of residents.

15. The computer-implemented method of claim 9 wherein, each neighborhood entry is associated with at least one broker entry wherein, a broker entry represents a real estate broker.

16. The computer-implemented method of claim 15 further comprising the step of enabling the user and a broker to communicate with one another.
